(19) United States
(12) Patent Application Publication
(10) Pub. No.: US 2019/0050889 A1
(43) Pub. Date: Feb. 14, 2019

(54) System and method for incentivizing credit card transactions at the point-of-sale

(71) Applicant: Checkout Ca$h, LLC, Pittsburgh, PA (US)

(72) Inventors: Gregory Halligan, Pittsburgh, PA (US); Nathan Marquiss, Bennington, NE (US)

(21) Appl. No.: 15/719,707

(22) Filed: Sep. 29, 2017

Related U.S. Application Data
(60) Provisional application No. 62/542,955, filed on Aug. 9, 2017.

(51) Int. Cl. G06Q 30/02; G06Q 20/20; G06Q 20/32; G06Q 20/10

(52) U.S. Cl. CPC G06Q 30/0238; G06Q 30/0236; G06Q 20/10; G06Q 20/3223; G06Q 20/20

(57) ABSTRACT

A computer program product to incentivize a user's selection of a credit card. Control logic for a mobile device causes the device to prompt a user to register a credit card. Credit card data for one or more credit cards is stored. The credit card issuer is made aware of a potential purchase and purchase amount from the user at the point-of-sale. In return, offers are sent and displayed to the consumer, from the credit card issuer, wherein the user can click and accept the offer, as a result use the credit card associated with the offer to the benefit of both the user and the credit card issuer.

### CROSS-REFERENCE TO RELATED APPLICATIONS

The present application claims benefit of provisional application Ser. No. 62/542,955 filed Aug. 9, 2017, the contents of which are incorporated herein by reference.

### BACKGROUND

### Field of the Invention

The present invention relates to consumer transactions at the point-of-sale. More particularly, just prior to checkout at a retail location, a user is provided, via a processor, an option to receive offers from the user's registered credit card issuers as a means for incentivizing the user to use the particular credit card at the point of sale.

### Description of the Related Art

Incentives to steer consumers to make a particular purchase or to use a particular payment method are widely used by a variety of entities. Credit card issuers have reward or point systems. Retail store locations use physical coupons. Online purchasers are offered discount and coupon codes by e-commerce sites. In today's e-commerce environment, promotional offers are instantaneous and widely competitive.

U.S. Pat. No. 8,412,629 to Masi shows an electronic fund transfer system wherein commissions for point-of-sale purchase transactions are determined and distributed to members of an organizational network for promoting use of a non-cash payment device that is tangible for effecting purchase transactions. U.S. Pat. No. 8,930,236 to Gillenson et al. relates generally to electronic commerce (e-commerce) systems and media platforms, for use with both mobile and non-mobile systems, to deploy virtual advertising and promotion via the use of electronic coupons, and more particularly a method and system for aggregating and distributing carbon reduction credits in connection with the creation and/or use of electronic coupons or virtual electronic rebates (VeeBates) and permitting individuals and groups within one or more social communications networks to participate in and transmit information to others about their activities related to the virtual advertising. U.S. Pat. Pub. No. 20030009393 to Norris describes a method, system, and computer for providing purchase transaction incentives using a financial product having an identification code that may be scanned at a point-of-sale terminal. The method comprises tracking a purchase transaction by a consumer based on identification data obtained from scanning of the identification code on the financial product. U.S. Pat. Pub. No. 20030216967 to Williams teaches a system, process and computer readable medium for providing purchasing incentives to a plurality of retailers from a central clearing location. The plurality of retailers transmit customer identifiers and, optionally, descriptions of customer purchases to a central incentive system via a communications system. The central incentive system determines purchasing incentives based on the customer identifiers and stored information and then transmits the purchasing incentives that have been associated with the customer identifiers to the originating retail store via the communications system. U.S. Pat. Pub. No. 20140019223 to Mavrikis describes a system and method provided for using payment cards. The method includes issuing promotion offers pertaining to the payment cards in real time. The method further includes redeeming the promotion offers in real time at a point of sale. U.S. Pat. Pub. No. 20150106187 to Berardi et al. teaches a system and method for providing incentives at a merchant location for using a RF identification (RFID) transaction device for transaction completion. Lastly, U.S. Pat. Pub. No. 20170017942 to Nix et al. teaches a payment processing system to provide merchant-specific accounts to consumers that are accessed by payment instruments. In one embodiment, the payment processing system can create and provide a variety of payment methodologies for purchases, such as pay-as-you-go, virtual prepaid, virtual subscription, and post-paid purchases. The merchant may, in some embodiments provide consumers with merchant rewards accounts and an opportunity to earn reward points or other loyalty-based currencies through qualifying purchase transactions.

As it relates to credit card usage, consumers are typically driven to use a particular credit card based on the credit card issuer's rewards system. Using a credit card over other payment means is preferred, not only out of convenience, but because most transactions are insured against fraud. Because of this, consumers typically have more than one credit card.

Consumers will carry their multiple credit cards, but most often use a “first-choice” credit card out of custom or because it has the best rewards system. The “second-choice” credit card is rarely used if, at the time of application, it did not have a rewards system or the point system was inferior. A “second choice” credit card might be used in some circumstances, but there is little incentive to use another credit card. The “second-choice” credit card not given priority results in a credit card issuer left without a transaction. In addition, if a user carries multiple credit cards, there is little reason to encourage the consumer to sign up for an additional card. In a marketplace of millions of credit card users, the revenue missed by the card issuer is significant.

There is a need then for a system and method which offers incentives to a user directly at the point-of-sale to motivate consumer behavior as between credit card choices, not merely as a steering mechanism for particular product purchases, as a result driving credit card loyalty and card issuer revenue.

### SUMMARY

It is an objective of the instant invention to offer incentives to motivate consumer behavior.

It is further an object of the invention to create partnerships with credit card companies and consumers.

It is further an object of the invention to drive credit card loyalty.

It is further an object of the invention to drive higher dollar and increased purchases on credit cards.

It is additionally an object of the instant invention to gather data on consumer preferences.

Accordingly, the invention comprehends, for instance, a computer program product comprising a non-transitory computer-readable medium having control logic stored therein for causing a computer to incentivize a user's selection of a credit card, the control logic comprising computer-readable program code for causing a device to: prompt a user to register a credit card; receive, from the user, a purchase amount data; transmitting the data to a credit card issuer; in return, via the control logic, sending offers provided by the credit card issuer to the user, wherein the user can click and accept the offer, as a result use the credit card associated with the offer to the benefit of both the user and the credit card issuer.

### BRIEF DESCRIPTION OF THE DRAWINGS

FIG. 1 is a diagrammatic illustration of the overall system architecture.

FIG. 2 shows a flow chart of the overall processor steps to incentivize the user selection of a credit card.

FIG. 3 shows a flow chart of the steps the user takes.

FIG. 4 shows example user interfaces on a smartphone having the control logic in the form of mobile application software.

### DETAILED DESCRIPTION OF THE PREFERRED EMBODIMENT

The flow charts, diagrammatic illustrations and/or sections thereof represent the method with computer control logic or program flow that can be executed by a specialized device or a computer and/or implemented on computer readable media or the like (residing on a drive or device after download) tangibly embodying the program of instructions. The executions are typically performed on a computer or specialized device as part of a global communications network such as the Internet. For example, a computer or mobile phone typically has a web browser or user interface installed within the CPU for allowing the viewing of information retrieved via a network on the display device. A network may also be construed as a local, ethernet connection or a global digital/broadband or wireless network or cloud computing network or the like. The specialized device, or “device” as termed herein, may include any device having circuitry or be a hand-held device, including but not limited to a tablet, smart phone, cellular phone or personal digital assistant (PDA) including but not limited to a mobile smartphone running a mobile software application (App). Accordingly, multiple modes of implementation are possible and “system” or “computer program product” or “non-transitory computer readable medium” covers these multiple modes.

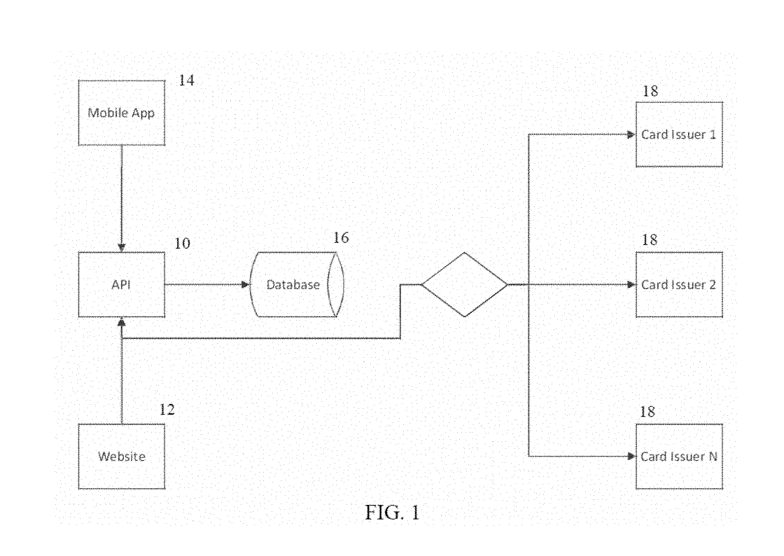

Referencing then FIG. 1, shown is the architecture or framework for the overall process and system. The application programming interface (API) 10 is used to build the application software, here taking the form of a website 12 and mobile application software (App.) 14. The API 10 is for a web-based system, allowing for the build-out of the mobile application software 14 which interacts with the database 16, card issuers 18 and the user as herein recited. Thus, a user such as a consumer at a retail location or even at home shopping online will primarily interact with the App. 14 via iOS or Android or any smartphone platform on their mobile device. The service provider will maintain an API 10 connection supporting the mobile application's API methods for creating new users/profiles, updating profiles, registering cards, viewing offer history as well as requesting offers from card issuers and presenting offers to end users. The service provider will build and maintain an API 10 connection to each card issuer 18. API 14 specifications could be determined by either the service provider or the card issuer 18. API 14 will allow registration and verification of card user as well as provide a method for requesting and presenting an offer based on any of: amount of sale; location of sale; type of sale. User profile data, offer history and basic card registration data will all be held in a secure database. In addition to providing apps in both the Apple iTunes and Android Play stores, the service provider will maintain API 14 and database 16 infrastructure hosted securely in various data centers. As used herein, therefore, mobile application software, App. 14 or service provider all have similar meaning and are used interchangeably.

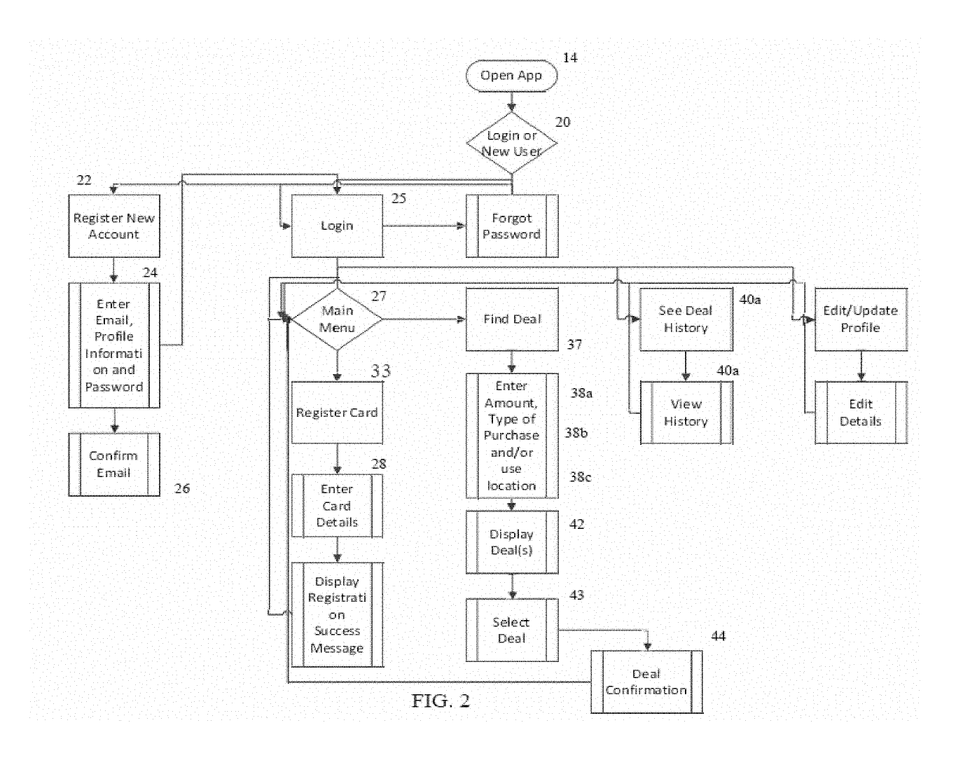

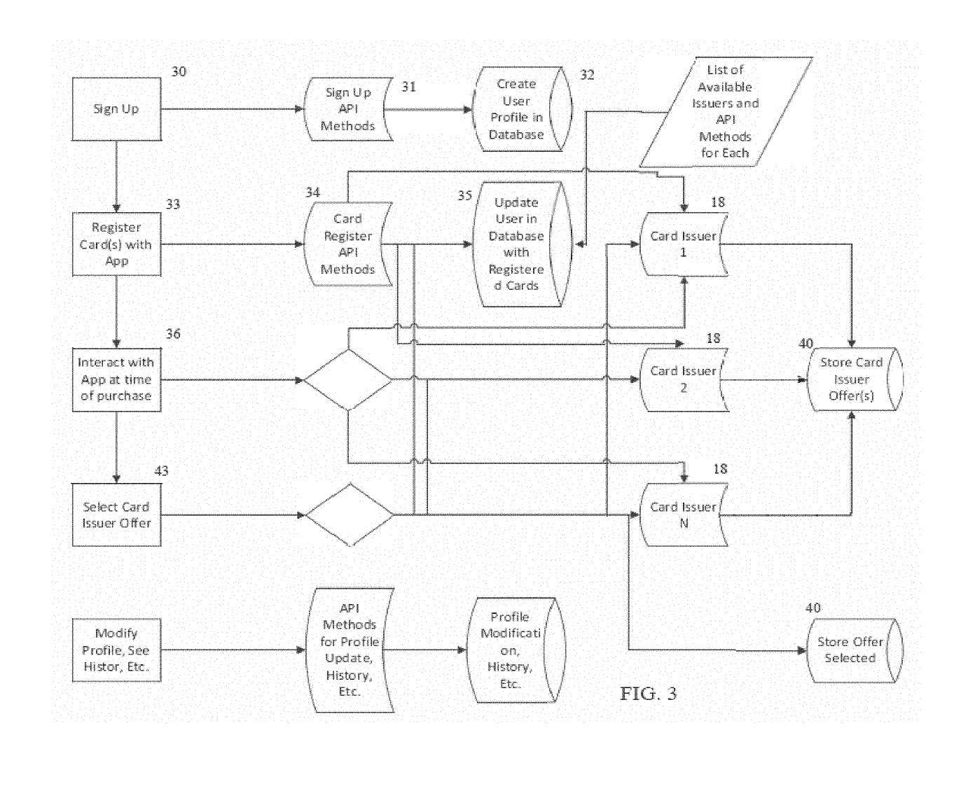

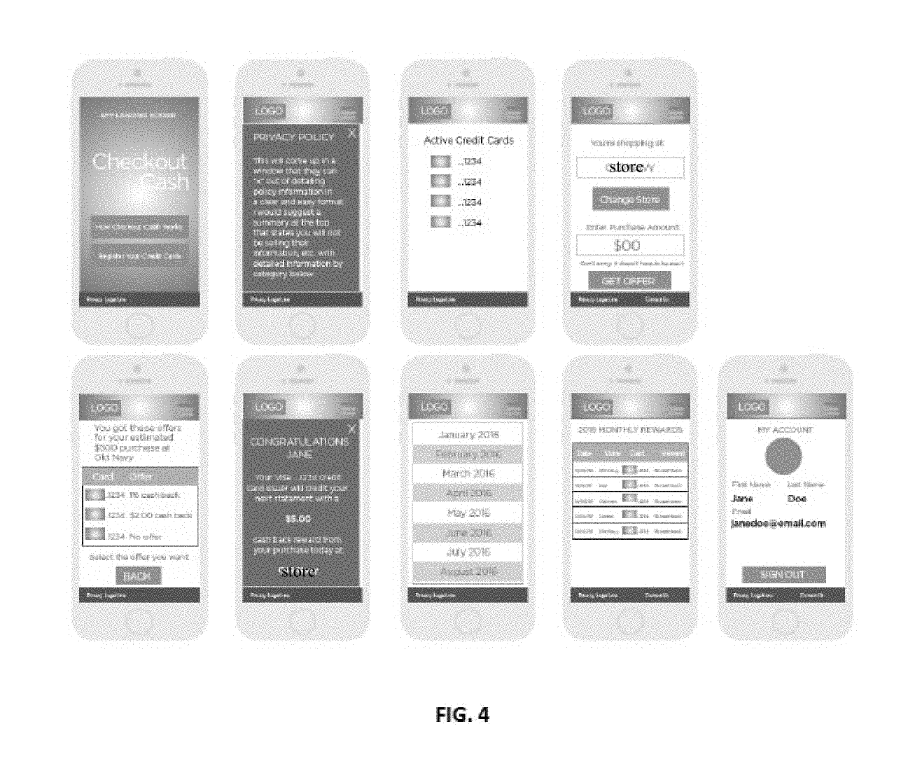

Referencing then FIGS. 2-4, upon first use, the user 20 opens the downloaded and installed App. 14 and will be prompted to register a new account 22, i.e. sign up 30 with the App 14, preferably providing a username and password as a login along with other basic user information, which is then stored in the database 16 (FIG. 1) as a user profile 32, created by the API 31. Once registration is completed with all information entered 24, a confirmation email can be sent 26, and the user 20 will immediately be prompted to login 25 and be prompted via an icon (asked) to register one or more credit cards 33 with the service provider. “Credit card” means any type of payment card, including but not limited to a credit card, debit card or charge card as would typically be issued by a third-party card issuer such as a bank. The API method 34 of registering the card 33 involves transmitting credit card data 33 to the service provider whereupon credit card data is stored on the server of the service provider 35. Card data may be hashed, partially stored, or a unique identifier can be stored which matches to the card number, rather than full card data. The amount and type of card data is dependent upon what the card provider allows for via API, the allowance of which is consented to via a separate agreement with the card issuer 18. User profile data 32 is thereby coupled with registered card data 33 to make a complete user profile. Such credit card registration requests and modifications of the stored credit card will be periodically accessible from a main menu 27.

Once a user's card or cards have been registered 33, the user 20 can begin to interact and use the App. at the point of sale to find a deal 36. “Point of sale” as used herein means any place where a transaction is completed, including but not limited to a retail store or an online location, thus the App. is not limited to use at a physical location, but rather any shopping experience. Just prior to checkout, the user will launch and interact with the App. 36 and begin to find a deal. The App.'s GPS can track and automatically insert the name of the store based on the user's location. Alternatively, the user can manually enter where they are, i.e. the name of the store, thus, in either instance, the name of the store is used, or generated 38c.

A proposed purchase amount 38a is then entered and perhaps the category of that purchase 38b. A proposed purchase amount 38a is purchase amount data that is either the exact, or “actual” amount of the price as determined by the store checkout process, or an estimated amount that can be determined or approximated by the user who might simply be examining and totaling the prices during the shopping experience. As should be understood by one of ordinary skill, the store checkout process can mean an online store cart ready to receive payment information, or be a store check-out clerk at a physical retail location, so any number of methods may be used to determine the proposed purchase amount 38a just prior to closing on the transaction. So, for example, at the check-out location the total of the purchase amount is established at the register, then the user inputs the proposed purchase amount into the populated box, which thereby becomes purchase amount data to be transmitted to the credit card issuer. Alternatively, the user can estimate the purchase price (proposed purchase amount 38a) at any time. No exact figure of the proposed purchase amount 38a is needed since the credit card issuer 18 will understand beforehand this definition, and thus they are made aware that the benefit or offer they are issuing may not apply to an exact dollar figure.

The purchase amount data 38a will be passed, via API, to one or more card issuers 18, depending on the number of registered cards for that user. Thus, the service provider receives the purchase amount data 38a from the user 20 and transmits the purchase amount data to the credit card issuer 18. Each card issuer 18 has access to a reporting portal where they will be able to store data 40 and view which card holders they have made an offer to and whether or not they have won the bid, i.e. deal or transaction history 40a. Card issuers will provide the user zero (0) or more offers based on the supplied criteria for display 42. An example offer would be: “Your Visa card ending in 6578 has offered 1.5% cash back.” Should the user desire, they can easily accept, via API, one of the provided offers 43 and proceed to checkout at the point of sale using the credit card selected. Appropriate confirmations can be sent 44.

Therefore, the service 14 has three (3) series of APIs: (a) first API to card issuer that purchaser/card holder is making a purchase for a certain amount at a certain location. This first API includes separate subsets of APIs to each card issuer 18 of the credit card that the purchaser/user 20 carries, e.g. if the purchaser has a Visa and an AMEX, each of them is sent the API for the proposed transaction; (b) each card issuer issues a reply of the offer via API; (c) a final API is sent to each card issuer if they have “won” the transaction. As a result, the card issuer 18 is benefitted by the transaction while the user 20 is benefitted by the issuer reward.

The App. 14 may also maintain a website whereby a user could login using their account credentials and see their offer and acceptance history as well as modify their account details and add or remove cards.

### Example

1. Three credit cards are registered with App. (Service Provider).

2. User submits that they are about to spend $500 at Location, which is populated with App. by GPS. The user types in “$500” and hits submit.

3. Service provider servers will route the user card numbers to the respective card issuers and that they are about to spend $500 at Location.

4. Issuers determine what their offer will be (if any), and this is routed back to Service Provider, then back to user.

5. User views, on one screen page, the three offers.

6. The user selects one of the three offers by clicking on it.

7. On assumption user chooses card #1234 for a 1% cash back on purchase instead of other two cards, the user gets a verification screen stating “are you sure you want the #1234 offer of 1% cash back?”

8. User hits “yes”.

9. User gets confirmation that card #1234 will issue a 1% cash back on $500, $5.00, on their next statement. User is done.

10. Service provider will update the three card issuers that they either won or did not win the bid.

I claim:

1. A computer program product comprising a non-transitory computer-readable medium having control logic stored therein for causing a device to incentivize a user's selection of a credit card, the control logic comprising computer-readable program code for causing the device to:
prompt a user to register a credit card with a service provider;
receive, from said user, a purchase amount data;
transmitting said purchase amount data to a credit card issuer;
in return, via the control logic, displaying zero or more offers provided by said credit card issuer to said user;
allow said user to click and accept said offer, as a result provide use of said credit card to a benefit of both said user and said credit card issuer.

2. The product of claim 1, wherein said user sends said purchase amount data from at a point-of-sale.

3. The product of claim 1, wherein after the step of prompting said user to register said credit card, credit card data is stored with said service provider.

4. The product of claim 2, wherein said purchase amount data is an actual amount to be paid by said user at said point-of-sale, said actual amount being generated at said point-of-sale.

5. The product of claim 2, wherein said purchase amount data is an estimate approximated by said user at said point-of-sale.

6. The product of claim 1, wherein a name of a store is generated and sent to said credit card issuer.

7. The product of claim 6, wherein said name is generated by being automatically populated and displayed to said user by said device.

8. The product of claim 6, wherein said name is entered into said device manually by said user.

9. The product of claim 1, further comprising generating a reporting portal for access by each said card issuer to provide a transaction history of said offers and the acceptances thereof.

10. A system for incentivizing a user's selection of a credit card, comprising:
a mobile device including a processor;
computer-readable medium having control logic stored in said mobile device for causing said mobile device to:
prompt a user to register a credit card with a service provider;
receive, from said user, a purchase amount data;
transmitting said purchase amount data to a credit card issuer;
in return, via the control logic, displaying zero or more offers provided by said credit card issuer to said user;
allow said user to click and accept said offer, as a result provide use of said credit card to a benefit of both said user and said credit card issuer.

11. The system of claim 1, wherein said user sends said purchase amount data from a point-of-sale.

12. The system of claim 1, wherein after the step of prompting said user to register said credit card, credit card data is stored with said service provider.

13. The system of claim 2, wherein said purchase amount data is an actual amount to be paid by said user at said point-of-sale, said actual amount being generated at said point-of-sale.

14. The system of claim 2, wherein said purchase amount data is an estimate approximated by said user at said point-of-sale.

15. The system of claim 1, wherein a name of a store is generated and sent to said credit card issuer.

16. The system of claim 6, wherein said name is generated by being automatically populated and displayed to said user by said device.

17. The system of claim 6, wherein said name is entered into said device manually by said user.

18. The system of claim 1, further comprising generating a reporting portal for access by each said card issuer to provide a transaction history of said offers and the acceptances thereof.
